(19) United States
(12) Patent Application Publication
(10) Pub. No.: US 2016/0091098 A1
(43) Pub. Date: Mar. 31, 2016

(54) Integrable Barrel Valve and Irrigation Piping Component Comprising Same

(71) Applicants: Scott A. Mosher, Melbourne, FL (US); Mark C. Brown, Melbourne, FL (US); Michael J. Swinson, Spring Hill, FL (US)

(72) Inventors: Scott A. Mosher, Melbourne, FL (US); Mark C. Brown, Melbourne, FL (US); Michael J. Swinson, Spring Hill, FL (US)

(21) Appl. No.: 14/871,016

(22) Filed: Sep. 30, 2015

Related U.S. Application Data
(60) Provisional application No. 62/057,427, filed on Sep. 30, 2014.

(51) Int. Cl. F16K 5/04

(52) U.S. Cl. CPC F16K 5/0407; F16K 5/0492; F16K 5/0478

(57) ABSTRACT

A piping component comprising a pipe member comprising a body section, a proximal section having a proximal opening, and a distal section having a distal opening, wherein the proximal and distal openings are in communication with one another to permit fluid to flow through the body section. The piping component further comprises a barrel valve adapted to be positioned at least partially within the body section comprising a barrel member and a rotation member connected to the barrel member. A bore is formed In the barrel member, When the barrel member is in a first orientation, the bore is aligned to permit fluid flow through the body section. When the barrel member is in a second orientation, the bore is aligned to prevent fluid flow through the body section.

### RELATED APPLICATIONS

This application claims the benefit under 35 U.S.C. §119(e) of U.S. Provisional Patent Application No. 62/057,427 titled Integrable Barrel Valve and irrigation Piping Component Comprising Same filed Sep. 30, 2014 (Attorney Docket No. 885.00003), the entire content of which is incorporated hereto by reference.

### FIELD OF THE INVENTION

The present invention relates to an integrable barrel and irrigation piping component.

### BACKGROUND

Context for the use and need of the apparatus m best summarized in U.S. Pat. No. 5,617,892 describing irrigation systems generally. As described therein, an irrigation system is used to dispense water to an area of land containing a lawn or garden. The system usually Includes a manifold from which extends a network of pipes terminated by sprinkler heads distributed over the land area being irrigated. The sprinkler heads are often of the pop-up type and project above the ground surface when the system is in use. The manifold is connected to a water source located adjacent to the land being irrigated.

Irrigation systems are turned on and of by opening and closing a valve using a valve handle. A pipe connects the water supply or mains to the valve inlet located upstream from the valve. The valve outlet, located downstream is connected by suitable pipes and fittings to the manifold of the irrigation system.

Prior irrigation shut off valves contain a combination of interior components that are complex to operate, maintain, and assemble. Therefore, there is a need in the art for a shut-off valve that contains few components and simplifies the operation, maintenance, and assembly; thereof. Accordingly, the piping component presented herein addresses this need.

This background information is presided to reveal information believed .by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a piping component comprising a pipe member comprising, the pipe, member comprising a body section, a proximal section having a proximal opening, and a distal section having a distal opening. The proximal and distal openings may be in communication with one another to permit fluid to flow through the body section. The piping component may further comprise a barrel valve adapted to be positioned at least partially within the body section. The barrel valve may comprise a barrel member and a rotation member connected to the barrel member. A bore may be formed in the barrel member. When the barrel member is in a first orientation, the bore may be aligned to permit fluid flow through the body section. When the barrel member is in a second orientation, the bore may be aligned to prevent fluid flow through the body section.

In some embodiments, an attachment member may be mounted on the pipe member body section exterior surrounding the rotation member. Additionally, the barrel member may be rotated by the rotation member. Furthermore, the proximal open end and the distal open end may be positioned with respect to each other within a range from 90 degrees to 180 degrees.

In some embodiments, the barrel member may further comprise a plurality of recesses, formed on the outer surface thereof to facilitate the placement of a gasket thereupon. The plurality of recesses may comprise an annular recess formed in a section of the outer surface of the barrel member between bore openings. Additionally, the piping component may further a gasket is placed upon the annular recess so as to form a seal about an inner circumference of the tubular section of the pipe member. In some embodiments, the plurality of recesses may comprise circumferential recesses and a pair of opposing gaskets placed upon the circumferential recesses and fitted as a seal to the portion of the barrel member located within the pipe, member body section. At least one of the pair of opposing gaskets may be located on the barrel member proximate to the rotation member. At least one of the pair of opposing gaskets may located on the barrel member distant to the rotation member.

In some embodiments, the proximal and distal sections may have an outer diameter within the range of ⅛″ to 7. Additionally, the barrel member may comprise a plurality of bores.

Embodiments of the present invention are also directed to a barrel valve for use in connection with a piping component, the barrel valve comprising a barrel member comprising openings formed therein, a body member carried by the barrel member, and a rotation member connected to the body member and configured to rotate the body member. A bore may be formed in the body member. The body member may be carried by the barrel member so as to rotate independently thereof. Furthermore, the barrel valve may be adapted to be carried by a pipe member that includes proximal and distal openings. When the barrel valve is carried by the pipe member and the body member is in a first orientation, the bore may be aligned with the openings of the barrel member to permit fluid flow through a body section of the pipe member. Additionally, when the barrel valve is carried by the pipe member and the body member is in a second orientation, the bore may be aligned with the openings of the barrel member to prevent fluid flow through the body section of the pipe member.

In some embodiments, the barrel valve may further comprise a plurality of gaskets, an annular recess formed in a section of an outer surface of the barrel member between bore openings, and at least two circumferential recesses formed, about the circumference of the outer surface of the barrel member; and wherein a gasket of the plurality of gaskets is placed upon each of the annular recess and the circumferential recesses.

### BRIEF DESCRIPTION OF THE DRAWINGS

FIG. 1 is a perspective view of a barrel valve according to an embodiment of the invention.

FIG. 2 is a side elevation view of the barrel valve of FIG. 1.

FIG. 3 is a top plan view of the barrel valve of FIG. 1.

FIG. 4 is a perspective view of a piping component according to an embodiment of the invention.

FIG. 5 is a perspective view of the piping component of FIG. 4 further comprising a barrel valve integrated therewith.

FIG. 8 is a front elevation view of the piping component of FIG. 5 with an indication of hidden lines to illustrate a flow of fluid through the piping component.

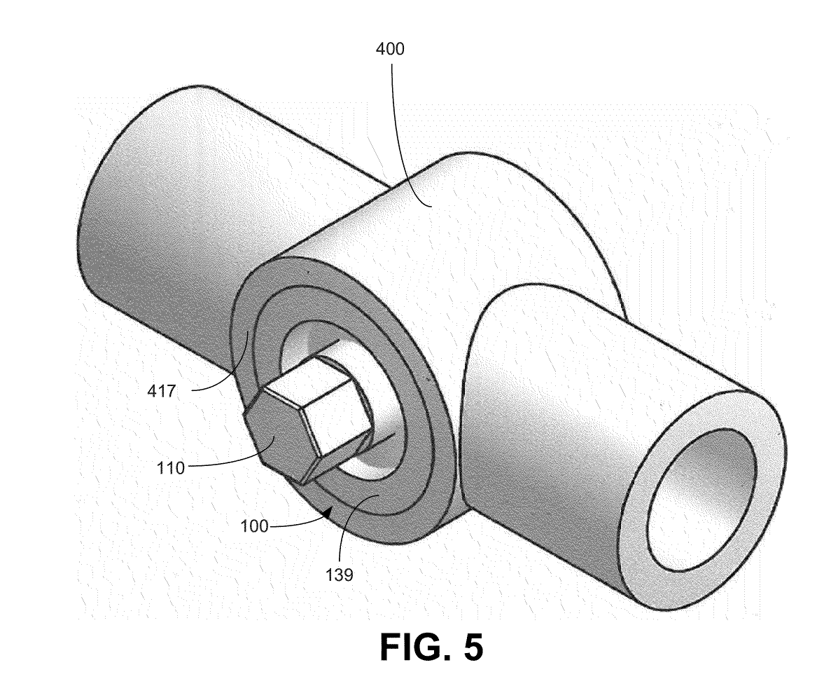

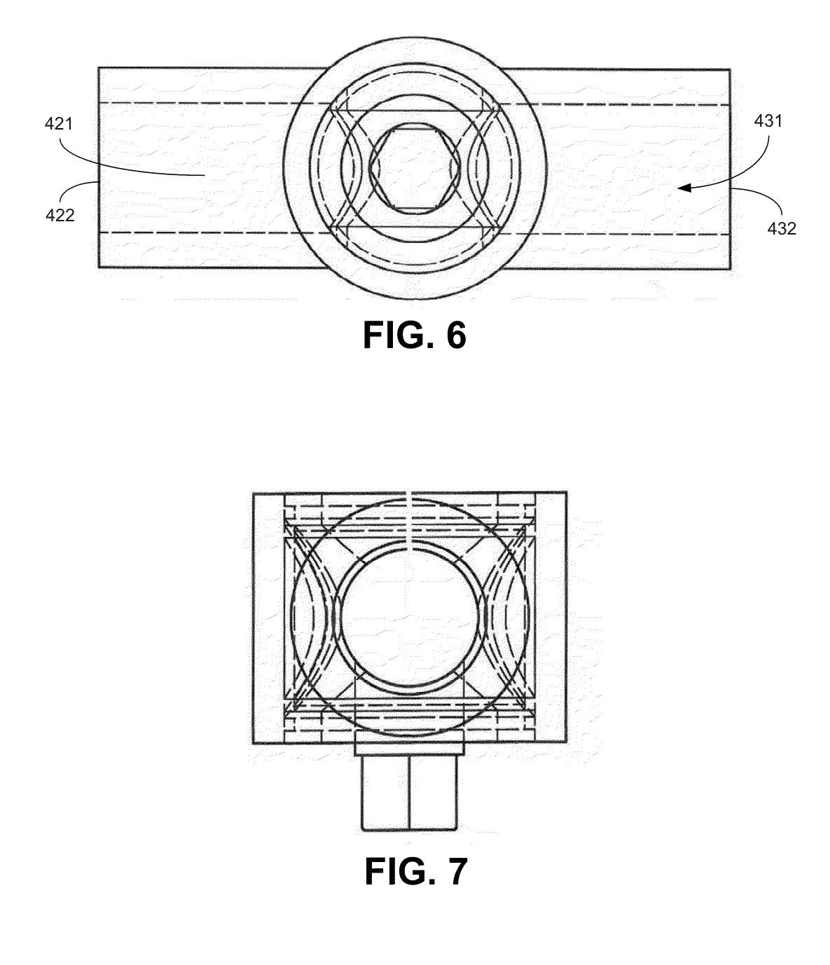

FIG. 7 is a side elevation view of the piping component of FIG. 5.

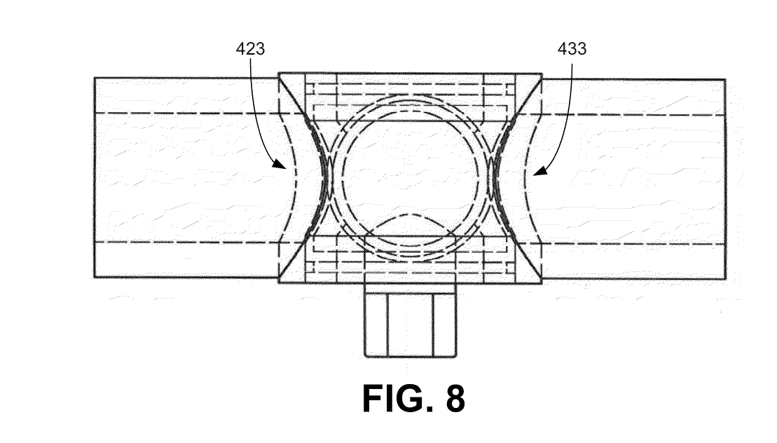

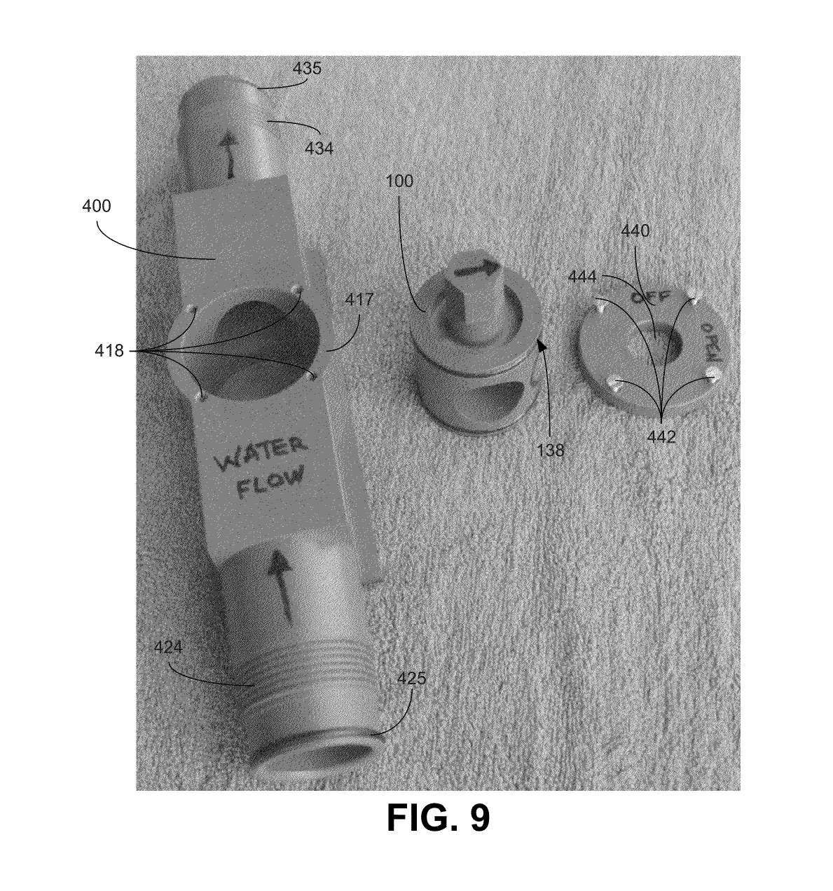

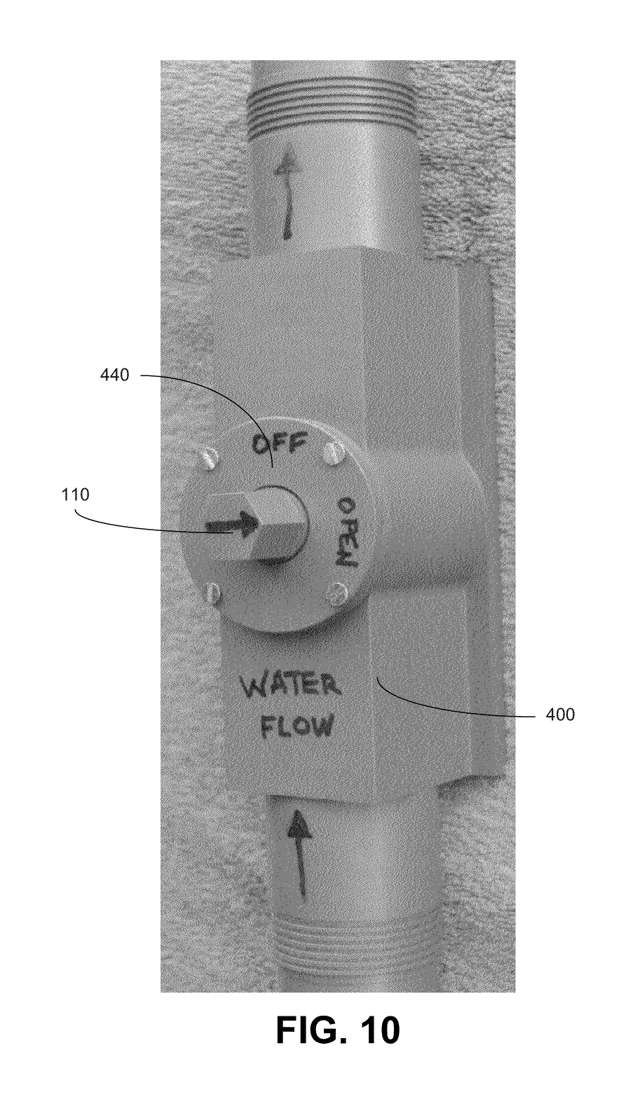

FIG. 8 is a top view of the piping component of FIG. 5.

FIG. 9 is a photograph showing a barrel valve, a piping component, and an attachment member according to the invention.

FIG. 10 is a photograph of the barrel valve, piping component, and attachment member illustrated in FIG. 9 in an assembled configuration.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not foe construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

In embodiment of the invention, as shown and described by the various figures and accompanying text, provides a barrel valve. The barrel valve is configured to be integrable with a piping component, such as a length of piping. The barrel valve may be integrable with the piping component so as to eliminate the need for discrete barrel valves, used in conjunction with adjacent lengths of piping, resulting in the concordant elimination of need for attending valves typically needed with employment of a barrel valve. The type of piping that the barrel valve may be integrable with may be formed of any material as is known In the art. While the present embodiment is directed towards integrability with polyvinyl chloride (PVC), any other polymer-, metal-, or metal alloy-based piping is contemplated and included within the scope of the invention.

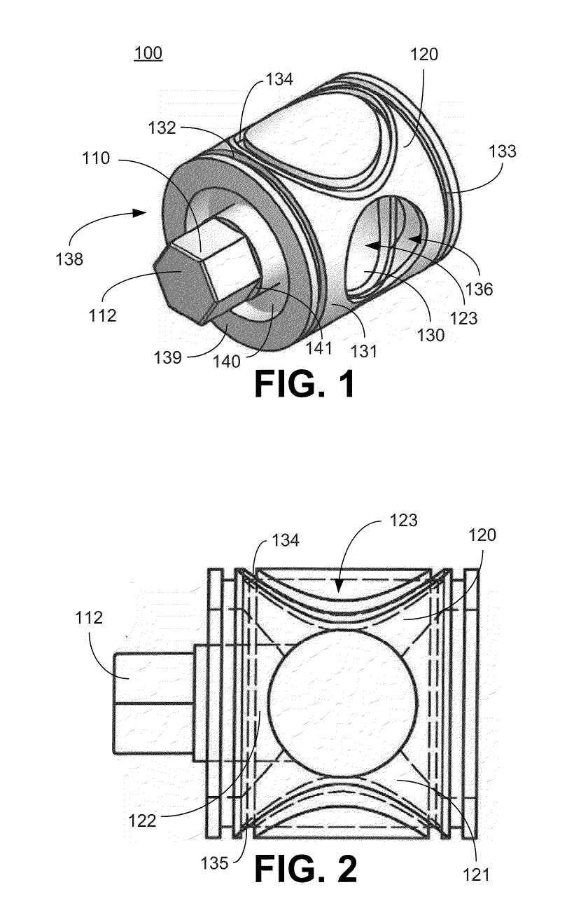

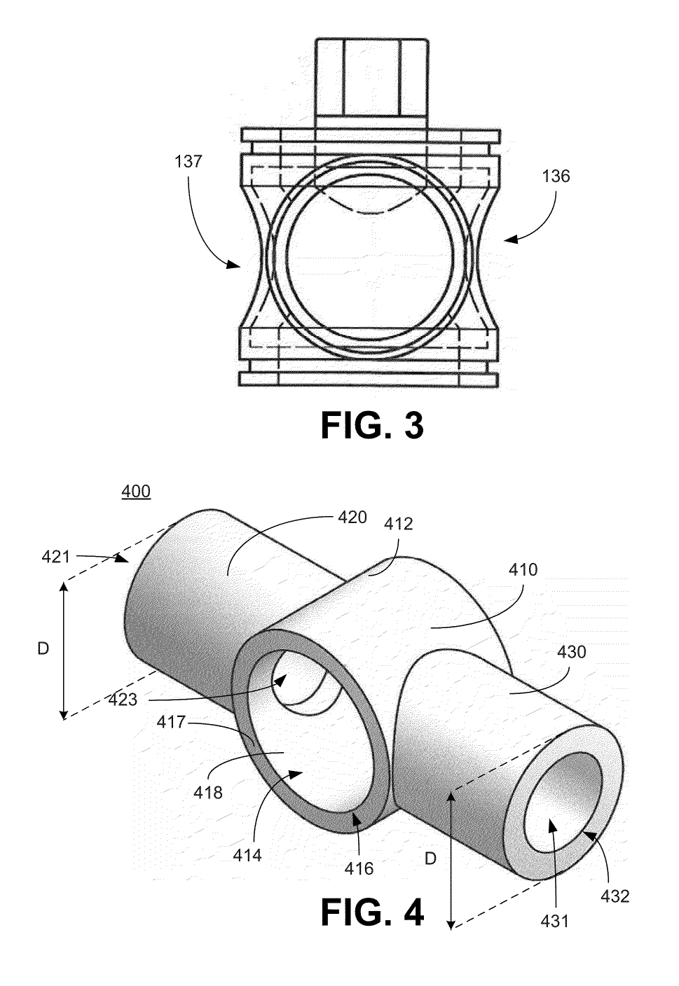

Referring now to FIGS. 1-3, a barrel valve 100 according to an embodiment of the invention will now be discussed. The barrel valve 100 may be configured to be integrated with a piping component to establish necessary seals and include structural components to enable functionality of barrel valves as known in the art.

The barrel valve 100 may comprise a rotation member 110, a barrel member 120, and a body member 130. The body member 130 may be configured to permit the barrel member 120 to be positioned therewithin such that the barrel member 120 may be rotated by the rotation member 110 while remaining inside the body member 130. Furthermore, the body member 130 may be configured to permit the attachment of the rotation member 110 to the barrel member 120 so as to enable the barrel member 120 to be rotated by the rotation member 110 without corresponding rotation of the body member 130.

The body member 130 may comprise a plurality of recesses. The plurality of recesses may be configured to facilitate the operation of the barrel valve 100. In some embodiments, the plurality of recesses may be configured to facilitate the placement of gasket members at least partially therewithin so as to restrain, reduce or completely prevent the flow of fluid around an outer surface 131 of the body member 130. Accordingly, in some embodiments, at least some of the plurality of recesses may be formed in the outer surface 131.

In the present embodiment, a first pair of recesses 132, 133 may be comprised in the outer surface 131. The first pair of recesses 132, 133 may comprise a first recess 132 located near an end of the body member 130 that is proximate to the rotation member 110. The first recess 132 may be formed about the circumference of the outer surface 131. The first pair of recesses 132, 133, may further comprise a second recess 133 located near an end of the body member 130 that is generally opposite the end that is proximate to the rotation member 110. The second recess 133 may be formed about the circumference of the outer surface 131. In some embodiments, the second recess 133 may be generally parallel to the first recess 132. The skilled in the art, however, will appreciate that the first recess 132 and the second recess 133 need not be parallel to one another in order to still accomplish the goals, features and objectives according to the present invention.

The first and second recesses 132, 133 may generally conform to the geometry of the outer surface 131 and facilitate the placement of a gasket therewithin. In the present embodiment each of the first and second recesses 132, 133 may facilitate the placement of an o-ring therewithin. Other types of gasket members as are known in the art are contemplated and included within the scope of the invention.

The body member 130 may further comprise a pair of openings 136, 137. The pair of openings 136, 137 may be formed In the body member 130 so as to enable the flow of fluid therethrough. In the present embodiment, the openings 136 are formed so as to oppose one another, being positioned on opposite sides of the outer surface 131. Other placements of the pair of openings 136, 137, such as at a 90° orientation respective to one another, a 135° orientation, and any other orientation, is contemplated and included within the scope of the invention.

Additionally, the openings 136, 137 may have any type of shape. In the present embodiment, each of the openings 136, 137 have a generally circular shape. Other shapes, including any polygonal shape, is contemplated and included within the scope of the invention. Furthermore, the openings 136, 137 may be configured to have the same shape, but of different dimensions. In some embodiments, the openings 136, 137 may have different shapes. In some embodiments, the openings 136 137 may be configured to have a shape that corresponds to the shape of an element of the barrel member 120, as will be described in greater detail hereinbelow.

In some embodiments, the body member 130 may further comprise a second pair of recesses, namely, a third recess 134 and a fourth recess 135. The third recess 134 may be positioned on the outer surface 131. Furthermore, the third recess 134 may be formed on the outer surface 131 so as to be positioned between the openings 136, 137. Additionally, the third recess 134 may be positioned between the first and second recesses 132, 133. The third recess 134 may have any polygonal shape. In the present embodiment, the third recess 134 has a generally circular shape, while still conforming to the shape of the outer surface 131. Similarly, the fourth recess 135 may be positioned on the outer surface 131 generally opposite the third recess 135, between the openings 136, 137 and between the first and second recesses 132, 133. The fourth recess 135 may have the same shape as the third recess 134, or it may have a different shape.

Additionally, each of the third and fourth recesses 134, 135 may be configured to facilitate the positioning of a gasket at least partially therewithin. The placement of the gasket at least partially therewithin may restrain, reduce, or completely prevent the flow of fluid around the outer surface 131. In the present embodiment, the third and fourth recesses 134, 135 may facilitate the placement of an o-ring at least partially therewithin. Furthermore, the positioning of gasket members at least partially within each of the first, second, third, and fourth recesses 132, 133, 134, 135 may enable each of the respective gasket members to cooperate in the prevention of fluid from flowing around the outer surface 131.

In some embodiments, the body member 130 may further comprise a proximal end surface 138, The proximal end surface 138 may be proximate to the rotation member 110. Furthermore, the proximal end surface 138 may comprise a first raised section 139, a recessed section 140, and a second raised section 141. The first raised section 139 may be formed generally about the periphery of the proximal end surface 138 and extend inward therefrom. The second raised section 141 may be formed generally at the center of the proximal end surface 138. The recessed section 140 may be positioned between the first raised section 139 and the second raised section 141. Furthermore, the second raised section 141 may be configured to facilitate the attachment of the rotation member 110 to the barrel member 120. In some embodiments, the second raised section 141 may comprise a port (not shown) therewithin configured to permit a portion of at least one of the rotation member 110 and the barrel member 120 to pass therethrough, facilitating attachment therebetween.

The barrel member 120 may be configured to selectively permit or prevent the flow of fluid through the barrel valve 100 dependent upon the orientation of the barrel member 120 with respect to the body member 130. The orientation of the barrel member 120 may be controlled by a user via manipulation of the rotation member 110.

The barrel member 120 may comprise a body section 121 and an attachment section 122. The body section 121 may be configured to be positioned within the body member 130. Furthermore, the body section 121 may comprise a bore 123. The bore 123 may be formed so as to permit fluid to flow through the body section 121 when the barrel member 120 is in a first orientation. Furthermore, in some embodiments, the bore 123 may be formed so as to prevent the flow of fluid through the body section 121 when the barrel member 120 is in a second orientation. Whereas the flow of fluid through the body section 121 when the barrel member 120 is in the first position represents a maximum fluid flow rate, any number of orientations of the barrel member 120 between the first and second orientations may permit a non-zero fluid flow rate that is less than the flow rate at the first orientation.

Additionally, the bore 123 may be formed so as to cooperate with the openings 136, 137 of the body member 130. In the present embodiment, where the openings 136, 137 are generally opposite one another, the bore 123 may be formed generally linearly through the body section 121. In other embodiments, where the openings 136, 137 are not opposite one another, the bore 123 may be at least one of curved or comprising a bend, or both, so as to facilitate the fluidic flow between the openings 136, 137 through the barrel member 130.

The attachment section 122 may be configured to attach to the rotation member 110 to facilitate rotation of the barrel member 120. In the present embodiment, the attachment section 122 may be configured to extend through the port of the second raised section 141.

The rotation member 110 may be attached to the barrel member 120 so as to enable a user to rotate the barrel member 120 into an orientation to selectively control the flow of fluid through the barrel valve 100. The rotation member 110 may be any structure or device that facilitates such rotation of the barrel member 120. In the present embodiment, the rotation member 110 comprises a head 112 that may be manipulable by a user, using either their hand or a tool, to rotate the head 112, thereby rotating the barrel member 120 via the attachment section 122. The head 112 may have any geometric configured, including any polygonal shape. In the present embodiment, the head 112 has a generally hexagonal shape and is configured to be manipulate by a tool, such as a wrench, ratcheting wrench, air or pneumatic ratcheting wrenches, socket wrench, and the like. In other embodiments, the rotation member 110 may be configured to automatically rotate the barrel member 120 responsive to a user input. Such systems may he electromechanical, hydraulic, pneumatic, or any other type of system capable of effectuating rotation of the barrel member 120.

In an alternative embodiment, the barrel valve 100 may be substantially similar to the previously-described barrel vale, with the exception of not including the body member 130. In such an embodiment, the rotation member 110 may be attached to the barrel member 120 such that when the bead 112 is rotated, the body member 120 is rotated accordingly, such that there is no relative rotation between the barrel member 120 and the head 112. Furthermore, the bore 123 may be configured to permit the flow of fluid therethrough. In the present embodiment, the bore 123 Is formed such that fluid may flow through the barrel valve 100, exiting 180° from where the fluid entered. It is contemplated and included within the scope of the invention that the bore 123 may be formed such fluid may flow through the barrel valve 100 and exit therefrom within the range from 90° to 180° from where the fluid entered. In some embodiments, the bore 123 may be curved. In some embodiments, the bore 123 may comprise a plurality of bores that meet to form an angle within the barrel member 120.

Referring now to FIGS. 4-8, a pipe member 400 according to an embodiment of the invention is presented. The pipe member 400 may be formed of any material that is suitable for use in irrigation, including, but not limited to, polyvinyl chloride (PVC). Other types of material may include polymers, metals, metal alloys, and composite materials.

The pipe member 400 may comprise a body section 410, a proximal section 420, and a distal section 430, in some embodiments, each of the body section 410, the proximal section 420, and the distal section 430 may be integrally formed as a single structure. The body section 410 may comprise a wall 412 that defines an interior chamber 414. The interior chamber 414 may be configured to permit a valve, such as the barrel valve 100 of FIGS. 1-3, therewithin. Furthermore, the interior chamber 414 may be configured to permit the operation of the barrel valve 100 so as to selectively permit or prevent the flow of fluid through the pipe member 400. Additionally, the body section 410 may comprise a valve receiving opening 418 configured to facilitate placement of the barrel valve 100 within the inferior chamber 414. The valve receiving opening 418 may be configured to permit, the barely valve 100 to pass therethrough, so as to permit the barrel valve 100 to be positioned at least partially within the interior chamber 414 so as to enable the above-described fluid flow.

In some embodiments, the body section 410 may comprise a receiving section surface 417. The receiving section surface 417 may be configured to cooperate with the barrel valve 100 in the positioning of the barrel valve 100 at least partially within the pipe member 400 so as to prevent relative translation therebetween while permitting rotation of various components of the barrel valve 100 as described hereinabove. Additional details regarding the positioning described above will be discussed in greater detail hereinbelow.

Additionally, the body section 410 may be configured so as to cooperate with elements of the barrel valve 100 to prevent the flow of fluid through the interior chamber 414 around the barrel valve 100. Accordingly, the body section 410 may be dimensioned so as to interface with an element of the barrel valve 100 to prevent such fluid flow. More specifically, the body section 410 may foe dimensioned such that an inner surface 418 may interface with at least one gasket of the barrel valve 100, such as any or all of gasket members positioned within the first, second, third, or fourth recesses 132, 133, 134, 135.

Each of the proximal and distal sections 420, 430 may be configured to permit fluidic flow therethrough. Accordingly, each may comprise a fluidic conduit 421, 431 configured to permit the flow of fluid. In some embodiments, each of the proximal and distal sections 420, 430 may be generally tubular. Furthermore, each may be generally annular in shape. Other geometries are contemplated and included within the scope of the invention. Additionally, each of the proximal and distal sections 420, 430 may be dimensioned so as to comply with standard sizes, such as ANSI of NSF, known in the art. For example, each of the proximal and distal sections 420, 430 may have an outer diameter D of within the range from approximately ⅛″ to approximately 7″, Specific embodiments include 2.3757 2.8.75″, 3.5″, 4.5″, 5.563″, and 6.825″. All other outer diameters D as are known in the art are contemplated and included within the scope of the invention. The dimensions of the proximal and distal sections 420, 430, may be approximately equal, or they may be unequal.

The proximal and distal sections 420, 430 may be connected to the body section 410 so as to establish fluidic communication between a proximal opening 422 of the proximal section 420 to a distal opening 432 of the distal section 430 via the Interior chamber 414. Accordingly, where each of the proximal and distal sections 420, 430 are connected to the body section 410, they may be connected so as to establish fluidic communication between each of the fluidic conduits 421, 431, which in turn may be in fluidic communication with the respective proximal and distal openings 422, 432.

Furthermore, the proximal and distal sections 420, 430 may be attached to the body section 410 so as to correspond to openings in the barrel valve 100. The attachment of the proximal and distal sections 420, 430 may define respective ports 423, 433 between the proximal and distal sections 420, 430 and the interior chamber 414. More specifically, the proximal and distal sections 420, 430 may be connected so as to align the respective ports 423, 433 with the openings 136, 137 of the barrel valve 100, thereby enabling the flow of fluid through the proximal section 420, through the barrel valve 100 positioned within the body section 410, and through the distal section 430. In the present embodiment, the proximal and distal sections 420, 430 are positioned generally opposite one another relative to the body section 410. In other embodiments, the proximal and distal sections 420, 430 may be connected to the body section 410 in any orientation relative to one another, including a 90° orientation.

Referring now specifically to FIG. 5, a barrel valve 100 is shown positioned partially within the interior chamber 414. The barrel valve 100 is positioned such that rotation member 110 protrudes from the pipe member 400 so as to manipulate to rotate the barrel member 120.

Furthermore, the first raised section 139 may be approximately flush with the receiving section surface 417. Such relative positioning, may facilitate the attachment of the barrel valve 100 to the pipe member 400, as may be seen in FIGS. 9-10.

In some embodiments, and with reference to FIGS. 9-10, the pipe member 400 may comprise an attachment member 440. The attachment member 440 may be configured to prevent the translation of the barrel valve 100 relative to the pipe member 400, specifically to prevent the barrel valve 100 from falling out of the interior chamber 414 and/or preventing the openings 136, 137 from coming out of alignment with the ports 423, 433. In the present embodiment, the attachment member 440 may comprise a plurality of fasteners 442, namely, screws. Additionally, the attachment member 440 may comprise am plurality of holed (not shown) configured to permit the plurality of fasteners 442 to pass therethrough. Furthermore, the receiving section surface 417 may comprise a plurality of holes 418 configured to cooperate with the plurality of fasteners 442, engaging with the fasteners 442 so as to attach the attach member 440 to the body section 410. Accordingly, the holes 418 may be threaded. The use of screws In the present embodiment is exemplary only, and any means or method of attachment as known in the art is contemplated and included within the scope of the invention. Additionally, the attachment of the attachment member 440 may facilitate the prevention of fluid from flowing out of the pipe member 400 through the opening 418.

In some embodiments, the attachment member 440 may define an aperture 444. The aperture 444 may be configured and positioned such that when the barrel valve 100 is positioned within the interior chamber 414, the protruding rotation member 110 may pass through the aperture 444 and be manipulate as described hereinabove. Furthermore, the aperture 444 may be dimensioned so as to overly at least a portion of the proximal end surface 138, preventing relative translation of the barrel valve 100 out of the interior chamber 414 by being abutted by the attachment member 440.

In some embodiments, at least one of the proximal and distal sections 420, 430 may comprise threads 424, 434. The threads 424, 434 may be configured to cooperate with any standard, such as ANSI or NSF, or non-standard threading as is known in the art. The number of threads per inch, starts, pitch, and other characteristics of the threads 424, 434 may depend on the outer diameter D of the proximal and distal sections 420, 430. In some embodiments, the threads 424, 434 may be configured to have threads per inch within the range from 4 to 12. In some embodiments, each of the threads 424, 434 may be configured to comply with the same standard threading as is known in the art. In some embodiments, one of the threads 424, 434 may be configured to comply with a first standard, and the other may be configured to comply with a differing standard. In some embodiments, one of the threads 424, 434 may be configured to comply with a first standard, and the other may be configured to comply with a proprietary standard other than those defined in the art. In some embodiments, each of the threads 424, 434 may comply with the above-described proprietary standard.

Referring now to FIG. 9, at least one of the proximal and distal sections 420, 430 may comprise respective recesses 425, 435. The recesses 425, 435 may be formed at any position along the proximal and distal sections 420, 430. In the present embodiment, the recess 425 of the proximal section 420 is formed proximal to the threads 424 of the proximal section 420, and the recess 435 of the distal section 430 may be formed distal to the threads 434 of the distal section 430. Each of the recesses 425, 435 may be configured to permit a gasket to be positioned therein. The recesses. 425, 435 may be configured to conform to the shape of the proximal and distal sections 420, 430 so as to provide a uniform depth. As shown in FIG. 9, an o-ring is positioned within the recess 425 of the proximal section 420. While an o-ring gasket is employed in the present embodiment, any type of gasket as are known in the art are contemplated and included within the scope of the invention, as well as recesses configured to accommodate the various types, of gaskets.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, if is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc, do not denote any order or importance, but rather the terms first, second, etc. are used to distinguish one element from another. Furthermore, the use of the terms a, an, etc. do not denote a limitation of quantity, but rather denote the presence of at least one of the referenced item.

That which is claimed is:

1. A piping component comprising:
a pipe member comprising:
a body section,
a proximal section having a proximal opening, and
a distal section having a distal opening,
wherein the proximal and distal openings are in communication with one another to permit fluid to flow through the body section;
a barrel valve adapted to be positioned at least partially within the body section comprising:
a barrel member, and
a rotation member connected to the barrel member,
wherein a bore is formed in the barrel member;
wherein when the barrel member is in a first orientation, the bore is aligned to permit fluid flow through the body section; and
wherein when the barrel member Is in a second orientation, the bore is aligned to prevent fluid flow through the body section.

2. The piping component according to claim 1 wherein an attachment member is mounted on the pipe member body section exterior surrounding the rotation member.

3. The piping component according to claim 1 wherein the barrel member may be rotated by the rotation member.

4. The pipe member according to claim 1 wherein the proximal open end and the distal open end are positioned with respect to each other within a range from 80 degrees to 180 degrees.

5. The piping component according to claim 1 wherein the barrel member further comprises a plurality of recesses formed on the outer surface thereof to facilitate the placement of a gasket thereupon.

6. The piping component according to claim 5 wherein the plurality of recesses comprises an annular recess formed in a section of the outer surface of the barrel member between bore openings.

7. The piping component according to claim 8 further comprising a gasket is placed upon the annular recess so as to form a seal about an inner circumference of the tubular section of the pipe member.

8. The piping component according to claim 5 wherein the plurality of recesses comprises circumferential recesses; and wherein the piping component further comprises a pair of opposing gaskets placed upon the circumferential recesses and fitted as a seal to the portion of the barrel member located within the pipe member body section.

9. The piping component according to claim 8 wherein at least one of the pair of opposing gaskets is located on the barrel member proximate to the rotation member.

10. The piping component, according to claim 8 wherein at least one of the pair of opposing gaskets is located on the barrel member distant to the rotation member.

11. The piping component according to claim 1 wherein the proximal and distal sections have an outer diameter within the range of ⅛″ to 7″.

12. The piping component according to claim 1 wherein the barrel member comprises a plurality of bores.

13. The piping component according to claim 1 wherein each of the proximal and distal sections of the pipe member comprise:
a recess formed in an outer surface thereof;
a gasket located within the recess; and
an attachment section;
wherein the attachment section of the proximal section is located distally of the recess of the proximal section; and
wherein the attachment section of the distal section is located proximally of the recess of the distal section.

14. A piping component comprising;
a pipe member comprising:
a body section,
a proximal section having a proximal opening, and
a distal section having a distal opening,
wherein the proximal and distal openings are in communication with one another to permit fluid to flow through the body section; and
a barrel valve adapted to he positioned at least partially within the body section comprising:
a barrel member,
a rotation member connected to the barrel member, and
a plurality of gaskets,
wherein a bore is formed in the barrel member,
wherein an annular recess is formed in a section of an outer surface of the barrel member between bore openings,
wherein at least two circumferential recesses are formed about the circumference of the outer surface of the barrel member, and
wherein a gasket of the plurality of gaskets is placed upon each of the annular recess and the circumferential recesses;
wherein when the barrel member is In a first orientation, the bore is aligned to permit fluid flow through the body section; and
wherein when the barrel member is In a second orientation, the bore is aligned to prevent fluid flow through the body section.

15. The piping component according to claim 14 wherein at least one of the plurality of gaskets is located proximate to the rotation member, and at least one of the plurality of gaskets is located distant to the rotation member.

18. The piping component according to claim 14 wherein the barrel member composes a plurality of bores.

17. The piping component according to claim 14 wherein the barrel member comprises a bore with opposing openings positioned 180 degrees from each other.

18. The piping component according to claim 14 wherein each of the proximal and distal sections of the pipe member comprise:
a recess formed in an outer surface thereof;
a gasket located within the recess; and
an attachment section;
wherein the attachment section of the proximal section is located distally of the recess of the proximal section; and
wherein the attachment section of the distal section is located proximally of the recess of the distal section.

19. A barrel valve for use in connection with a piping component, the barrel valve comprising;
a barrel member comprising openings formed therein;
a body member carried by the barrel member; and
a rotation/member connected to the body member and configured to rotate the body member;
wherein a bore is formed in the body member;
wherein the body member is carried by the barrel member so as to rotate independently thereof:
wherein the barrel valve is adapted to be carried by a pipe member that includes proximal and distal openings;
wherein when the barrel valve is carried by the pipe member and the body member is in a first orientation, the bore is aligned with the openings of the barrel member to permit fluid flow through a body section of the pipe member; and
wherein when the barrel valve is carried by the pipe member and the body member is in a second orientation, the bore is aligned with the openings of the barrel member to prevent fluid flow through the body section of the pipe member.

20. The barrel valve according to claim 19 further comprising a plurality of gaskets; wherein an annular recess Is formed in a section of an outer surface of the barrel member between bore openings; wherein at least two circumferential recesses are formed about the circumference of the outer surface of the barrel member; and wherein a gasket of the plurality of gaskets is placed upon each of the annular recess and the circumferential recesses.
